(19) United States
(12) Patent Application Publication
(10) Pub. No.: US 2010/0321811 A1
(43) Pub. Date: Dec. 23, 2010

(54) DRIVE LIFE CYCLE MANAGEMENT

(75) Inventors: Michael Gerard Goberis, Broomfield, CO (US); Matthew Thomas Starr, Lafayette, CO (US); Jeff Robert Boyton, Fort Collins, CO (US); Walter Wong, Boulder, CO (US); Nathan Christopher Thompson, Boulder, CO (US)

Correspondence Address: Spectra Logic Corporation, 1700 North 55th Street, Boulder, CO, 80301, US

(73) Assignee: Spectra Logic Corporation, Boulder, CO (US)

(21) Appl. No.: 12/819,919

(22) Filed: Jun. 21, 2010

Related U.S. Application Data
(60) Provisional application No. 61/218,795, filed on Jun. 19, 2009.

(51) Int. Cl. G11B 27/36; G11B 15/68

(52) U.S. Cl. 360/31; 360/92.1; G9B/27.052; G9B/15.135

(57) ABSTRACT

Described are a method and apparatus that monitor tape drive health for tape drives in a tape library. The tape library generally contains a data base that is adapted to maintain functional status records for interactions that occur when a tape drive physically engages a tape cartridge. More specifically, errors associated with tape drive and tape cartridge interactions can be stored in the data base and monitored to make determinations relative to problems encountered by a specific tape drive.

### CROSS-REFERENCE TO RELATED APPLICATIONS

This application claims priority to and the benefit of U.S. Provisional Patent Application No. 61/218,795 entitled: Drive Life Cycle Management, filed on Jun. 19, 2009, the entire disclosure of which is hereby incorporated by reference.

### BACKGROUND OF THE INVENTION

1. Field of the Invention

The present invention relates generally to tape libraries using auxiliary memory devices contained in tape storage cartridges to record functional status information related to tape drives.

2. Description of Related Art

Data storage libraries, such as tape libraries, are typically used to store and retrieve large amounts of data for data manipulation and archiving purposes. These libraries are generally comprised of drive devices adapted to read and write data to and from tape cartridges that are often housed within the tape libraries. In the interest of obtaining cursory information about a specific tape cartridge without requiring a time-consuming media load and tape threading process to read the on-tape index file, techniques using holes arranged in patterns in the cartridge casing and later electrical pads grounded in a variety of combinations were introduced. The holes and/or electrical pads provided simple information such as tape capacity, manufacturer, etc. Today, these techniques are yielding to the introduction of Radio Frequency chips disposed in the tape cartridges called a Memory-In-Cartridge (MIC) or Medium Auxiliary Memory (MAM), because of increased amounts of information and ease of use. FIG. 1A shows an example of a tape cartridge 100, tape medium 102, and MIC 104, shown here in dashed lines because the MIC 104 and tape medium 102 reside in the interior of the cartridge 100. In this example, the MIC is disposed in an LTO-3 cartridge which can be provided by TDK Corp. of Tustin, Calif.

A MIC allows the tape drive to access valuable cartridge data without the use of a physical connection, reducing connector wear for both the drive and the media. The MIC is a memory chip built into the data cartridge that provides a direct and immediate connection to the drive's on-board processors, which speeds access to information related to the data cartridge such as system logs, for example. Information and file search parameters are formatted within the MIC system effectively cutting the data access time down to a fraction from historical techniques.

As shown in FIG. 1B, a MIC 104 fundamentally comprises an integrated circuit that includes solid state memory and a transponder 124 attached to an antenna 126, the antenna is typically a small coil of wires. The MIC 104 is considered a passive device because it is energized when subjected to a strong enough RF field produced by a MIC-Reader. Information can be transmitted between the MIC and the MIC-Reader via a specific radio frequency.

Currently a MIC, or MAM, is parceled into regions for a medium, device and host. The three regions can accommodate attributes related to a medium with a MIC. For example a medium attribute can be a serial number permanently stored in the MAM during manufacturing, a device attribute can be load count maintained by the tape drive and a host attribute can be a backup date maintained by the application client. These attributes are strictly read and written to by a reader disposed in a drive.

In an effort to expand capabilities of a storage element containing a MIC operable with a tape drives functional status when loaded with a cartridge, both methods and apparatus are disclosed herein. It is to innovations related to this subject matter that the claimed invention is generally directed.

### SUMMARY OF THE INVENTION

The present invention relates generally to tape libraries using auxiliary memory devices contained in tape cartridges to record functional status information related to tape drives overcoming the disadvantages and limitations of the prior art by making the functional status information available to an end user via the tape cartridge's radio frequency memory device.

One embodiment of the present invention can therefore comprise a tape storage library comprising: a plurality of tape cartridges each including an associated auxiliary memory device; a first tape drive and a second tape drive substantially disposed in the tape storage library; a data base adapted to maintain functional status records respecting each interaction, wherein the interaction is defined by a physical engagement between one of the tape cartridges and one of the tape drives; a means for transferring the functional status records of at least one of the interactions from the data base to one of the auxiliary memory devices such that the associated tape cartridge possesses a history of the interactions specific to the tape cartridge; a data analysis system adapted to perform an analysis of the functional status records maintained in the data base; and a reporting system adapted to report a tape drive health condition of the first and the second tape drives to an end user based on the analysis of the functional status records.

Other embodiments of the present invention may additionally comprise a tape library comprising: a plurality of tape drives and a plurality of tape cartridges substantially disposed in the tape library; a database including a plurality of interaction assessment records corresponding to a plurality of respective interaction events wherein each of the interaction events comprises physical and electrical sequences associated with any of the tape cartridges and any of the tape drives when physically engaged, and wherein each of the interaction assessment records includes a tape drive indicia associated with one of the tape drives, a tape cartridge indicia associated with one of the tape cartridges, and a functional status of the interaction events a table listing the functional statuses for the interaction events involving each of the tape drives.

Yet further embodiments of the present invention may comprise a method comprising: providing a tape library including a plurality of tape cartridges, a plurality of tape drives, and a data base; forming an interaction between one of the tape cartridges and one of the tape drives wherein the interaction is defined by a physical engagement between the one tape cartridge and the one tape drive; assessing a first functional status associated with the interaction; recording in the data base the assessed first functional status in association with an identification of the one tape cartridge and the one tape drive; determining whether the data base has recorded any other assessed function status associated with an interaction between others of the tape cartridges and others of the tape drives; correlating the first function status with any the other assessed functional status recorded in the data base according to predetermined parameters; reporting the correlation to an end user.

### BRIEF DESCRIPTION OF THE DRAWINGS

FIG. 1A is a prior art pictorial representation of a tape cartridge with an auxiliary radio frequency memory device.

FIG. 1B is a prior art pictorial representation of an auxiliary radio frequency memory device.

FIG. 2A is an illustration of a tape cartridge arrangement comprising a magnetic recording tape medium interacting with a tape drive and with functional status information displayed on a single character display constructed in accordance with an embodiment of the present invention.

FIG. 2B is an illustration of a populated tape cartridge magazine in accordance with an embodiment of the present invention.

FIG. 3 is an illustration an embodiment of a shelf system that comprises an auxiliary memory reader that can be used in combination with a loaded tape cartridge magazine in accordance with an embodiment of the present invention.

FIG. 4 is an illustration of a transport unit and auxiliary memory reader arrangement in accordance with an embodiment of the present invention.

FIG. 5 shows an embodiment of an auxiliary radio frequency reader and writer device located at the library entry/exit port location consistent with embodiments of the present invention.

FIG. 6A-6C shows various embodiments of a displayed data table pertaining to historical tape drive functional status related information as recorded on a tape cartridges auxiliary radio frequency memory device in accordance with an embodiment of the present invention.

FIG. 7 is a block diagram illustrating a central data base acting as a repository for information pertaining to a plurality of tape cartridges in a plurality of libraries in accordance with an embodiment of the present invention.

FIG. 8 shows a commercial embodiment of one T-950 library unit wherein aspects of the present invention can be practiced.

FIG. 9 is a block diagram illustrating a method to practice an embodiment of the present invention.

FIG. 10 is a block diagram illustrating an alternative method to practice an embodiment of the present invention.

### DETAILED DESCRIPTION

U.S. Provisional Patent Application No. 61/218,795 entitled: Drive Life Cycle Management, filed on Jun. 19, 2009 is hereby incorporated by reference in the present Provisional United States patent application.

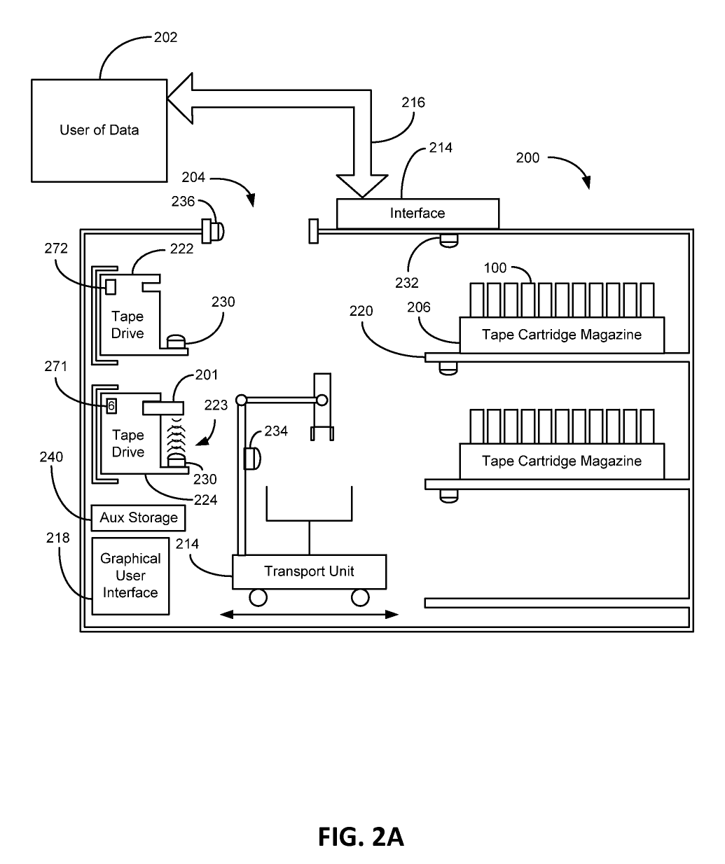

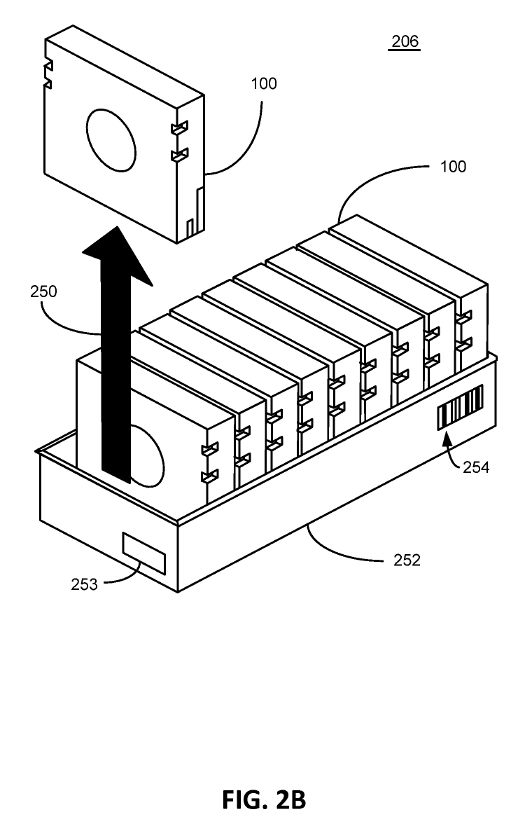

Referring to the drawings in general, and more specifically to FIG. 2A, shown therein is an illustration of a data storage arrangement constructed in accordance with an embodiment of the present invention. In what follows, similar or identical structures may be identified using identical callouts.

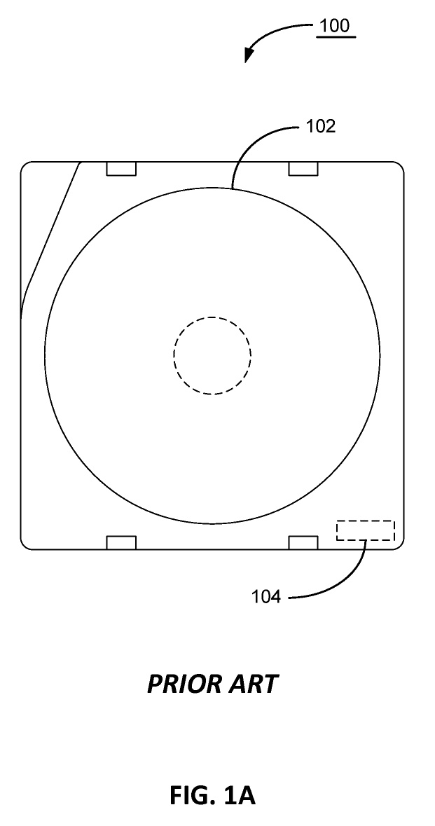

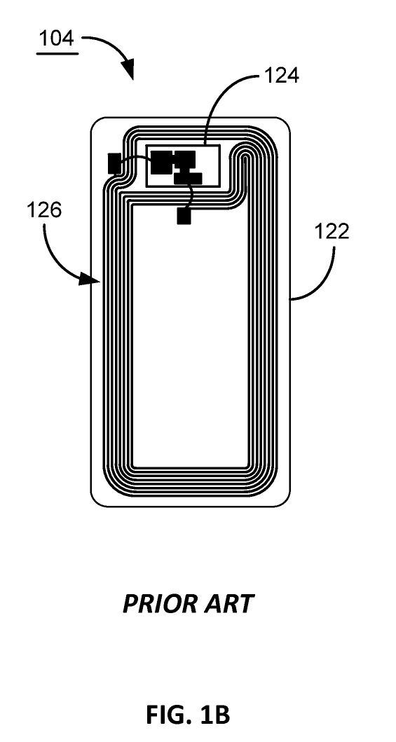

The data storage arrangement illustrated in FIG. 2A can comprise a user of data 202, such as a client, in communication 216 with a data storage library 200. As illustratively shown, the client 202 is in communication with the library 200 via the communication path 216 and the library interface device 214. The library 200 comprises a plurality of tape cartridges 100, such as those disposed in a tape cartridge magazine 206, wherein each of the tape cartridges contains an auxiliary memory device, such as an auxiliary radio frequency memory device 104 of FIG. 1B). The auxiliary memory devices are capable of retaining auxiliary digital data. In this embodiment, the library 200 also comprises several tape drives 222 and 224, each capable of reading user data from and writing user data to one each of the plurality of tape cartridges 100. Optionally, there can be a plurality of tape drives in an alternative embodiment. User data herein is considered data from a source such as the user of data 202 that is stored on the tape medium 102, of FIG. 1A. Each tape drive 222 and 224 can be associated with a tape drive auxiliary memory reader and writer device, such as a radio frequency reader and writer device 230, as shown. Here, the tape drive auxiliary memory reader and writer device transmits data that is stored on a tape's auxiliary memory device, such as the MAM 104. For purposes of illustration, the radio frequency auxiliary memory device 104 may be used herein as an exemplary embodiment of the auxiliary memory device, which can include miniature storage devices that form an electrical link as opposed to a wireless link, for example.

Each tape drive 222 and 224 can further comprise a Single Character Display (SCD) 271 and 272 (or optionally a display that includes more than one character) that corresponds to the functional status of the respective drives 224 and 222 when interacting with a tape cartridge 100. As shown, the tape drive 224 is interacting with a tape cartridge 201 when there is physical engagement between the tape drive 224 and tape cartridge 201, e.g., the tape cartridge 201 is loaded in the tape drive 224. An example of a loaded tape drive is the tape cartridge 201 inserted in the tape drive 224 in a cooperating reading and writing relationship where user data can be stored and read from the tape medium 102 contained substantially by the cartridge 201. Physical engagement through the interaction between a tape cartridge 201 and tape drive 224 can be from when the tape cartridge 201 is first physically introduced to the tape drive 224, such as when the tape cartridge 201 is being inserted in the tape drive 224, to when the tape cartridge 201 is ejected and being removed from the tape drive 224.

Loading a tape cartridge 100 in a tape drive 222 or 224 requires physical and electrical sequences when engaged. For example, the tape cartridge 201 is in a functionally ready state with the first tape drive 224 when the tape cartridge 201 is operable to perform data exchange operations. A functional ready state is a state wherein the first tape cartridge 201 (or any tape cartridge) is adequately loaded in a tape drive; that is, the tape cartridge 201 progresses through a series of loading sequences to “come ready”, i.e., become operable to perform data exchange operations. Generally, a tape cartridge 100 is inserted in an opening in a compatible tape drive, such as the first tape drive 224, Upon entering the tape drive, an arm mechanism associated with the tape drive unlocks a spring-loaded latch associated with the tape cartridge 100, thereby enabling another device associated with the tape drive to open the tape medium access door. Spindle motor devices engage the reel or reels on which the tape medium is wound. In the case of a leader type tape structure, another mechanism associated with the tape drive grasps the tape medium leader and threads the tape through drum devices and into close proximity to tape heads associated with the tape drive used to read and write data on the tape medium. Once fully loaded, the tape cartridge is physically arranged in a condition ready to store or retrieve data for a host.

As shown here, the loaded tape drive 224 is also in radio frequency communication 223 with the auxiliary radio frequency memory device 104 (not shown) associated with tape cartridge 201 via the tape drive radio frequency reader and writer device 230 associated with tape drive 224. As illustratively shown, the SCD 271 associated with the loaded tape drive 224 has displayed a functional status corresponding to the number “6” which may be indicative of a specific error code of an incident associated with a tape cartridge and tape drive interaction, for example. Hence, the SCD displays the functional information that may be associated with an error during a tape cartridge and tape drive interaction as a single character representation, such as “0”, “3”, “5”, “6”, “B”, “Z”, etc. For instance, an LTO-3 tape drive, manufactured by IBM from of Armonk, N.Y., comprises an SCD wherein the SCD corresponding to “6” is indicative of a tape drive or media error, which is an error indeterminate of whether the root cause of error is the tape drive or tape cartridge. Other examples of SCD functional status errors includes no error found, drive cooling problem, power problem with the drive, firmware problem with the library when interfacing (i.e., communicatively linked) with the drive, tape drive firmware problem, tape drive hardware problem, media error, combination tape drive and media error, bus failure, and drive needs to be cleaned, just to name a few examples. Of course, there is a functional status that indicates that there is a trouble-free interaction, that is, a tape cartridge and tape drive interaction that is devoid of any error and is operating in a manner consistent with an expected interaction outcome that is free of any unexpected errors. After determining the functional status of the tape cartridge 201 interacting with the tape drive 224, the tape drive 224 can transmit the functional status information, such as that shown on the SCD 271, to the auxiliary radio frequency memory device 104 associated with the loaded tape cartridge 201 and/or the auxiliary storage device 240, which can function as a data base adapted to maintain functional status information tied to each and every tape cartridge 100 and 201 and interactions with tape drives 222 and 224. An example of the auxiliary storage device 240 being adapted to maintain functional status can be via a table that is populated with tape drive indicia (such as tape drive serial number or location), tape cartridge indicia (such as tape cartridge serial number, for example), and records of associated functional statuses of respective interactions, i.e., these data are tied together for each interaction. In this example, the table can be updated each time a tape cartridge 100 or 201 interacts with a tape drive 222 or 224.

Optionally, the tape drive 224 or 222 can read the historical functional status information corresponding to one or more previous load events that are stored on the auxiliary radio frequency memory device 104 associated with the loaded tape cartridge, such as tape cartridge 201, via the tape drive radio frequency reader and writer device 230. Once read, the historical functional status can be sent to the auxiliary storage device 240, for example. The auxiliary storage location 240 can accommodate information from a plurality of auxiliary radio frequency memory devices 104 in cumulative ways. In another embodiment of the present invention, SCD information from one or more tape cartridges 100 can be manipulated via a data analysis system that includes an algorithm that includes electronically stored readable and executable instructions, an associated computing devices, such as memory 240 or flash or other memory both volatile and non-volatile, processors, and the like. Such a data analysis system can be provided by the library 200 via a library central processing unit, or computer, to execute the algorithm/s to generate statistical data about the first tape drive 222, the second tape drive 224, or both. Based on the statistical data associated with the functional status records, a report can be generated pertaining one or more tape drive's 222 and 224 health condition/s. The reporting system can generate the report directing attention to tape drive health and transmit it viewably to an end user. The reporting system can include one or more algorithms that can run on the same library central processing unit as the data analysis system and can include a display device, such as the graphical user interface 218, to display the report to an end user, for example. Optionally, if one of the tape drives 222 or 224 is considered problematic, action to remedy the problem can be automatically performed, such as cleaning a tape drive or replacing a tape drive. In another embodiment, the statistics generated can be further retained in the auxiliary storage device 240, or some other location, for example.

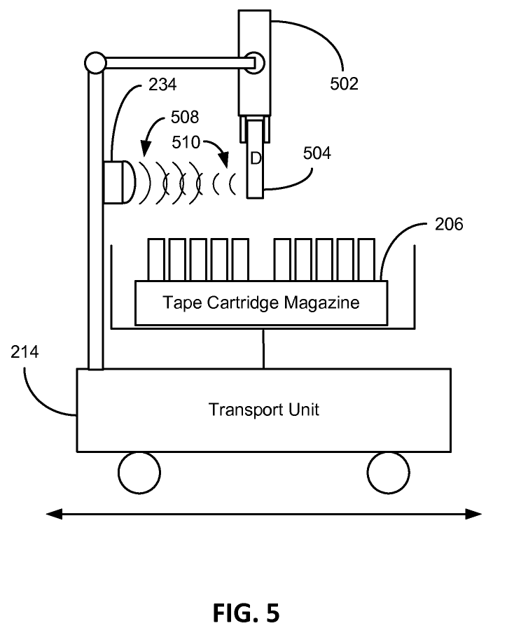

The library 200 can further comprise a shelving system 220 capable of archiving the tape cartridge magazines 206 within the library 200. In this embodiment, the shelving system 220 is associated with one or more auxiliary radio frequency reader and writer device 232 that is at least capable of reading data, such as the SCD information, stored on an auxiliary radio frequency memory device 104 contained by each tape cartridge 100. A transport unit 214 comprises means to transport a tape cartridge magazine 206 from the shelf system 220 to a location that facilitates a tape cartridge 100 to be inserted in one of the drives 222 or 224, such as tape cartridge 201 in a cooperating relationship with drive 224 to read and write data as shown. The transport device 214 can optionally be associated with at least one auxiliary radio frequency reader and writer device 234, as shown here, disposed on the transport unit 214. The library 200 also optionally comprises an entry/exit port 204 whereby tape cartridges 100 or tape cartridge magazines 206 can be transferred between an environment external to the library 200 and an environment internal to the library 200. As shown here, at least one auxiliary radio frequency reader and writer device reader 236 is associated with the entry/exit port 204. The auxiliary radio frequency reader and writer devices 232, 234 and 236 are independent of the tape drive radio frequency reader and writer device 230, i.e., devices 232, 234 and 236 are disposed in a location not associated with a tape drive. In this embodiment, the library 200 can accommodate a graphical user interface 218 and an auxiliary memory 240, such as a disk drive or solid state memory device, capable of retaining (storing) relevant information related to each tape 100, such as that which is stored on an auxiliary radio frequency memory device 104. In one embodiment, the tape cartridges 100 or the tape cartridge magazines may be associated with different user of data such that the storage space in the library 200 is partitioned into two or more parts wherein each part is associated with the different user of data for example. With reference to FIG. 2B, shown therein are tape cartridges 100 supported by a tape cartridge magazine 206. In more detail, a tape cartridge 100, such as an LTO-3 category tape cartridge manufactured by IBM, comprises magnetic tape that is capable of storing digital data written by a compatible drive 220 or 224, such as an LTO tape drive manufactured by IBM, when in cooperation (i.e. loaded) with the tape cartridge 201 as shown in FIG. 2A. The tape cartridge magazine 206 is shown populated with a plurality of tape cartridges 100. A tape cartridge 100 can be removed from the tape cartridge magazine 206, as shown by the arrow 250, and inserted in to the tape drive 220 or 224 by means of a picker device 502, shown in FIG. 5. Disposed on the tape cartridge magazine 252 is a bar code identifier 254 for identifying the tape cartridge magazine 206 which has utility should the tape cartridge magazine 206 be archived in a media pack storage vault, for example. In this embodiment, all tape cartridges 100 contain an auxiliary radio frequency memory device 104, however, in alternative embodiments, some tape cartridges may not contain an auxiliary radio frequency memory device 104. In another embodiment of the present invention, the magazine 206 can comprise a magazine auxiliary memory device 253 that is capable of containing information from at least one of the data cartridges 100 the magazine 206 supports. The magazine auxiliary memory device 253 can receive information from the auxiliary radio frequency memory devices 104 contained by each tape cartridge 100 via one or more auxiliary radio frequency reader and writer devices 232, 234 or 236, for example. Information from the auxiliary radio frequency memory devices 104 can be read and immediately transmitted to the magazine auxiliary memory device 253, or alternatively, the information of each auxiliary radio frequency memory devices 104 can be stored on the auxiliary storage device 240 and then transferred to the magazine auxiliary memory device 253, just to name two examples.

An auxiliary radio frequency memory device 104, in one embodiment, is parceled into three regions in which data can be stored; a medium device region which contains information such as a serial number, a device region which contains information from the tape drive such as load count, and host/vendor unique region wherein information such as history and/or performance data related to the cartridge 100 can be stored. The information in the regions can be added to with new information via an address related to the arrangement of available storage space in the auxiliary radio frequency memory device 104 or, optionally, the information can be read by an auxiliary memory reader, such as the reader 230, and reassembled with additional information and stored on the auxiliary radio frequency memory device 104 as the reassembled version, just to name two examples. In another example, if the storage limit is reached in the auxiliary radio frequency memory device 104, such as the host/vendor data in the host/vendor unique region, the host/vendor data can be read and stored in an auxiliary storage space, such as the auxiliary memory 240, and the host/vendor unique region purged and made available for new information. In another example, the host/vendor data can be compressed with algorithms to decompress residing in the library 200 or user of data 202, for example.

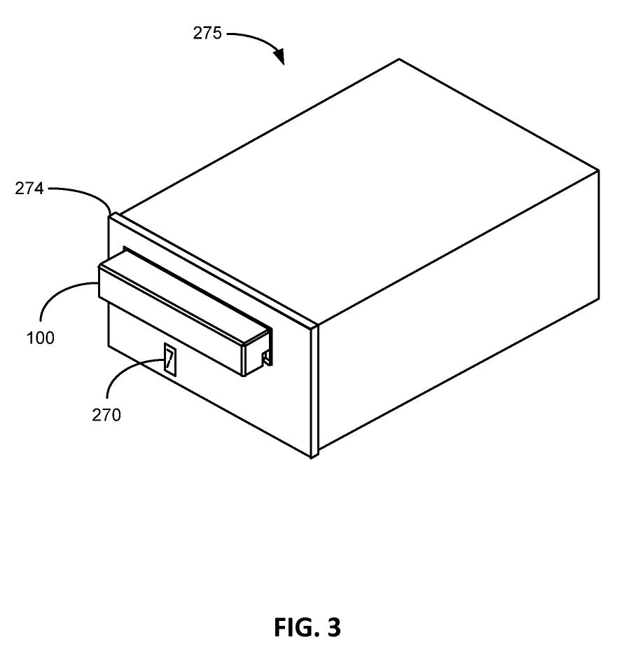

With reference to FIG. 3, shown therein is an illustration of a tape drive 275 according to some embodiments of the present invention. As shown, the tape cartridge 100 is loaded in the tape drive 275 via a receiving opening in the drive face 274 to form a cooperating read and write relationship. The tape drive 275 is capable of identifying drive/cartridge 275 and 100 functional status and displaying the functional status via an SCD 270 featured on the drive face 274. The tape drive 275 further possesses an auxiliary memory reader and writer device (not shown), that transfers information associated with the functional status, i.e., the SCD information, to the auxiliary radio frequency memory device 104 associated with the tape 100 wherein the information is in a form consistent with kind of auxiliary digital data stored in the auxiliary radio frequency memory device 104. The auxiliary memory reader and writer device associated with the tape drive 275 can also read the historical functional status information stored on the tape's auxiliary radio frequency memory device 104. The historical functional status information is the information accrued from previous occasions that tape cartridge 100 was loaded in the (or a different) tape drive 275. The tape drive 275 can then transmit the functional and/or historical functional status information to the graphical user interface 218, the user of data 202, the auxiliary storage device 240, or an alternative location to where an end user can view the data either directly or indirectly.

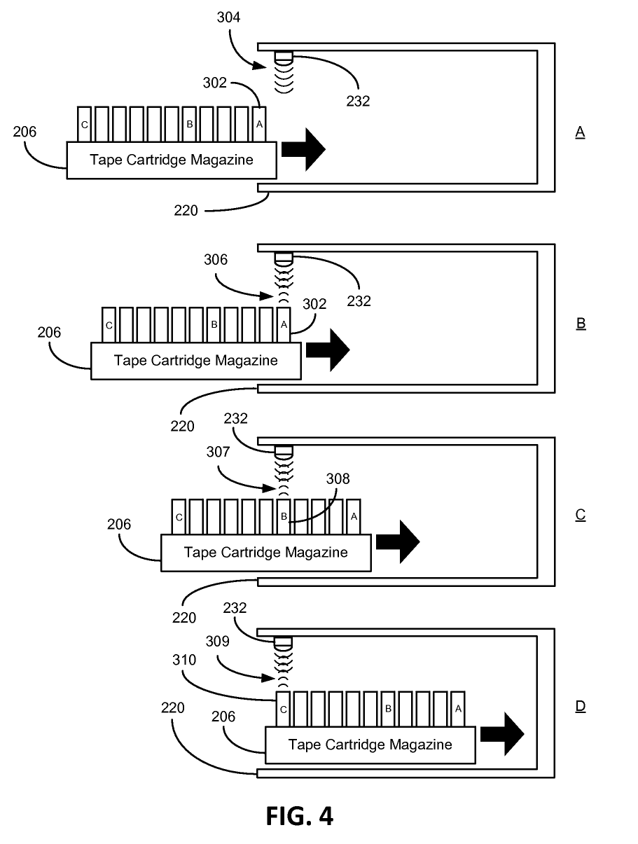

FIG. 4 illustrates an embodiment of a shelf system 220 that comprises an auxiliary memory reader 232 that can be used in combination with a loaded tape cartridge magazine 206. As illustratively shown in arrangement-A, the tape cartridge magazine 206 is in the process of being moved on to the shelf 220 in the direction of the arrow. The auxiliary memory reader 232 is shown transmitting an RF field 304 via an auxiliary radio frequency memory device 104 contained in cartridge A 302. Arrangement-B illustrates the auxiliary radio frequency memory device 104 contained in tape cartridge A 302 transmitting data, such as SCD information relative the history of loads associated with cartridge A 302, in the form of an RF signal 306 to the auxiliary memory reader 232 when positioned in the presence of the RF field 304. In one embodiment of the present invention, the auxiliary radio frequency memory device 104 is a passive device because it is energized when subjected to a strong enough RF field produced by the auxiliary memory reader 232. Information is transmitted between the auxiliary radio frequency memory device 104 and the auxiliary memory reader 232 via a specific radio frequency, shown here as 304 and 306. Data can be transferred and stored on the auxiliary radio frequency memory device 104 from the library 200 or alternatively (and in addition to) data from the auxiliary radio frequency memory device 104 can be transferred to the auxiliary memory 240 via the auxiliary memory reader 232. Arrangement-C illustrates the auxiliary radio frequency memory device 104 contained in tape cartridge B 308 transmitting data in the form of an RF signal 307 to the auxiliary memory reader 232 when positioned in the presence of the RF field 304. Arrangement-D illustrates the auxiliary radio frequency memory device 104 contained in tape cartridge C 310 transmitting data in the form of an RF signal 309 to the auxiliary memory reader 232 when positioned in the presence of the RF field 304.

With reference to FIG. 5, shown therein is an illustration of the transport unit 214, of FIG. 2A, in greater detail. The transport unit 214 is adapted to transport tape cartridge magazines 206 within the library 200. A cartridge picker 502, which can be associated with the transport unit 214, is adapted to move cartridges 100 from a tape cartridge magazine 206 into a cooperating read/write relationship with a tape drive, such as tape drive 224 of FIG. 2A. The transport unit 214 is illustratively shown herein accommodating an auxiliary memory reader 234 that is transmitting an RF signal 508 (and potentially data) to an auxiliary radio frequency memory device 104 contained in tape cartridge D 504 whereby the auxiliary radio frequency memory device 104 of cartridge D 504 is transmitting data, such as historical SCD information, via an RF signal 510 to the auxiliary memory reader 234.

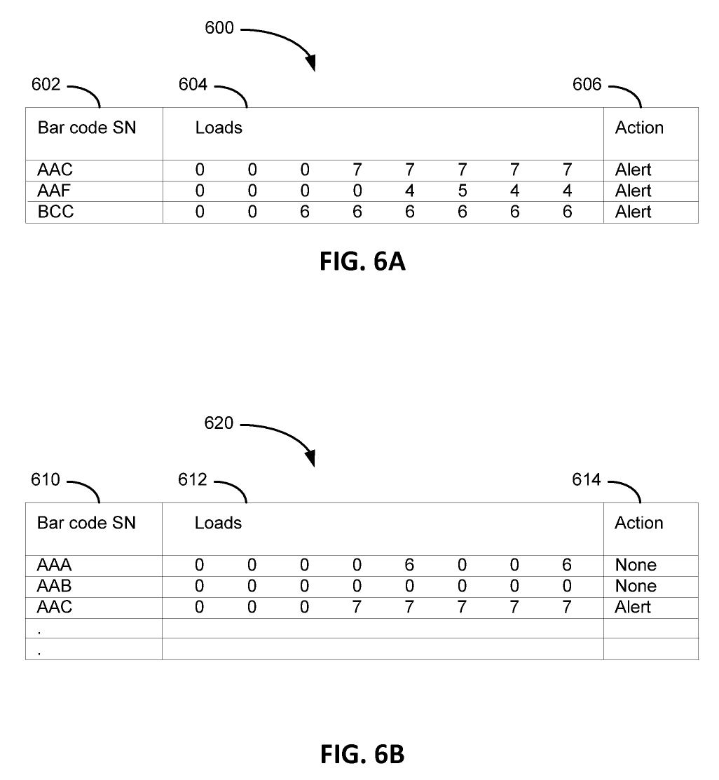

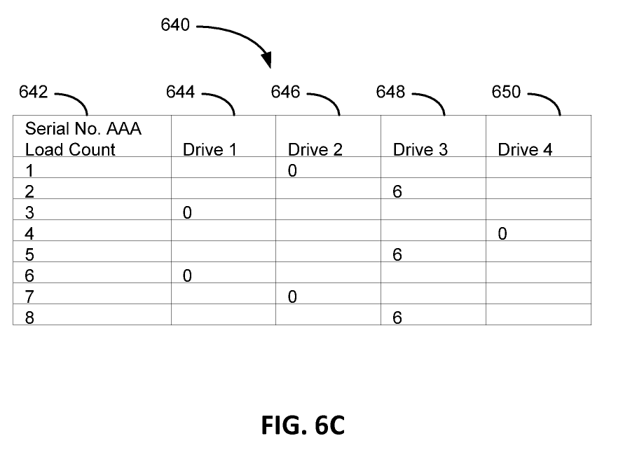

Data, including functional drive/cartridge status information, from each tape cartridge's auxiliary radio frequency memory device 104, obtained by an auxiliary radio frequency reader and writer device, such as 230, 232, 234, or the like, can be stored on an auxiliary storage device 240 associated with the library 200. Optionally, the data can be stored in memory associated in an alternative location, such as with the host 202, for example. Because many potential attributes can be stored on an auxiliary radio frequency memory device 104, the manner in which the data can be displayed may be organized in accordance with specific needs. For example, each recorded cartridge can have an associated file where upon opening the file, one can choose which attribute to display. Alternatively, a display can include a handful of most frequently viewed data or data filtered according to specific performance related thresholds. Illustrative examples are shown in FIGS. 6A-6C.

With reference to FIG. 6A, shown therein is one example of a displayed data table 600 pertaining to alert action based on functional status information, and more specifically, SCD information. The table 600 can be generated from multiple tape cartridge SCD information that are cumulatively stored on the auxiliary storage device 240 and displayed on the graphical user interface 218, a remote monitor or some other display device that can be viewed by an end user or operator, for example. As previously discussed, the SCD information for each tape cartridge 100 can optionally be read from the cartridge's associated auxiliary radio frequency memory device 104 and transmitted via an auxiliary radio frequency reader and writer device, such as 230, 232, 234, 236, or some other means for transmitting the SCD information, to an end user. The SCD information is sorted by an action 606 to replace a cartridge 100 which, in this example, is an excessive number of load errors. As illustrated, three columns are displayed, namely; the tape cartridge bar code serial number 602, the SCD functional status of time a tape cartridge is loaded in a drive 604 and the action to replace a tape cartridge 606. Here, the number of load errors recorded that exceed four causes an alert action 606. As illustratively shown, bar code serial number AAC has an action to be replaced because of five errors that are identified as an SCD error code “7”. Bar code serial number AAF has an action to be replaced because of four errors that are in sequence “4, 5, 4, 4”. Bar code serial number BCC has an action to be replaced because of six errors that are identified as an SCD error code “6”. A decision to replace the tape cartridge, repair a drive, or replace a drive can be left up to an operator or end user or can optionally be automatically accomplished by the library 200, for example.

FIG. 6B shows an alternative example of a displayed data table 620 showing all tape cartridges in a library. As illustrated, three columns are displayed, namely; the tape cartridge bar code serial number 610 in order, the corresponding SCD functional status of time a tape cartridge is loaded in a drive 612 and the action to replace a corresponding tape cartridge 614. As in the example of FIG. 6A, the number of load errors recorded that exceed four causes an alert action. As illustratively shown bar code AAA has posted two errors that are identified as an SCD error code “6”, hence no action is needed at the current time. Bar code AAB has no errors posted, and as illustratively shown in FIG. 6A, bar code serial number AAC has an action to be replaced because of five errors that are identified as an SCD error code “7”. The bar code serial number column 610 continues as indicated by the “..”.

FIG. 6C shows an alternative example of a displayed data table 640 showing just tape cartridge AAA and a list of SCD of four tape drives that are used with tape cartridge AAA. All of the tape drives comprise an SCD, such as that provided by an IBM LTO-3 tape drive, though some drives do not possess SCDs, nonetheless, such drives may be able to determine functional status. As illustrated, five columns are displayed, namely, tape cartridge serial number AAA load count arranged in successive loads 642, drive-1 load status 644, drive-2 load status 646, drive-3 load status 648 and drive-4 load status 650. As illustrated, for loads 2, 5 and 8, drive-3 is registering error 6, which may be a tape drive or media error displayed by drive-3. As such, an operator or user of data may arrive at the conclusion that drive-3 is broken or may need servicing. Optionally, an analysis system can execute an algorithm that an algorithm that reports a tape drive health condition, namely tape drive 3 in this example, as being problematic if a threshold of accumulated errors is reached. For example, if three errors are reached then a user of data can be alerted that drive 3 may have a problem. Optionally, a user of data may be alerted if a single error that is deemed severe, such as no power for example. These limits and thresholds can be predetermined and set by a user of data, the library original manufacturer, a host, etc. The registered SCD of 0 indicates that no error occurred. A tape drive's health can be affirmed as good based on a tally of trouble-free interactions or mostly trouble-free interactions. Optionally, a tape drive's health can be judged based on a ratio of total errors versus trouble-free interactions. Yet another example of determining tape drive health can include number of errors over time, for example, if there were a grouping of errors all of a sudden an alert may be sent out versus if errors were dispersed occasionally between trouble-free interactions, no alert may be sent out. The table in FIG. 6C is one example of a report that presents tape drive health.

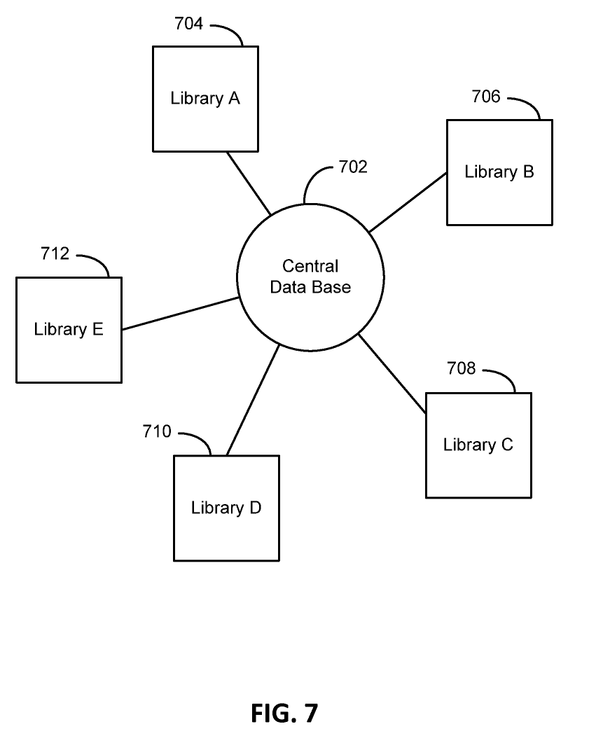

FIG. 7 is a block diagram illustrating a central data base 702 acting as a repository for information pertaining to at least each tape cartridge associated with each library. As shown in the illustrative arrangement, library A 704, B 706, C 708, D 710 and E 712 are each linked to the central data base 702. The central data base 702 can provide storage of any, and all, interaction assessment records directly from the tape drives 222 and 224, or optionally, the auxiliary radio frequency memory device information contained in each tape cartridge associated with each library A-E 704-712. In one embodiment, all of the tape cartridges comprised by library A 704 may each comprise an auxiliary radio frequency memory device, such as the device 104. The central data base 702 can, therefore, contain all of the information from each of the auxiliary radio frequency memory devices from library A 704 and/or information transmitted directly from the tape drive 222 and 224. The central data base 702 can further be adapted to sort the information in any number of ways including the exemplary arrangements of FIGS. 6A-6C. Interaction assessment records can correspond to a plurality of respective interaction events wherein each of interaction event can include physical and electrical sequences associated with any of the tape cartridges and any of the tape drives when physically engaged. Each of the interaction assessment records can include a tape drive indicia associated with one of the tape drives (e.g. a tape drive identification such as a world-wide name address or serial number), a tape cartridge indicia associated with one of the tape cartridges (e.g. a bar code), and a functional status of the interaction events. Library B 706 may comprise tape cartridges that do not have an auxiliary radio frequency memory device, thus, only those that do have an auxiliary radio frequency memory device can store associated information on the central data base 702. Library C 708 may include some cartridges with an attribute associated with each auxiliary radio frequency memory device that bars storing any associated information on the central data base 702, hence, only those cartridges that are allowed to be stored (i.e., not bared) on the central data base 702 are stored. The interaction assessment records stored on the central data base can be viewed by an authority, such as an Original Equipment Manufacturer of libraries and/or tapes, for purposes of tape management, such as replacing damaged or worn out tapes or tape drives or notifying a user of data if something out of the ordinary has occurred.

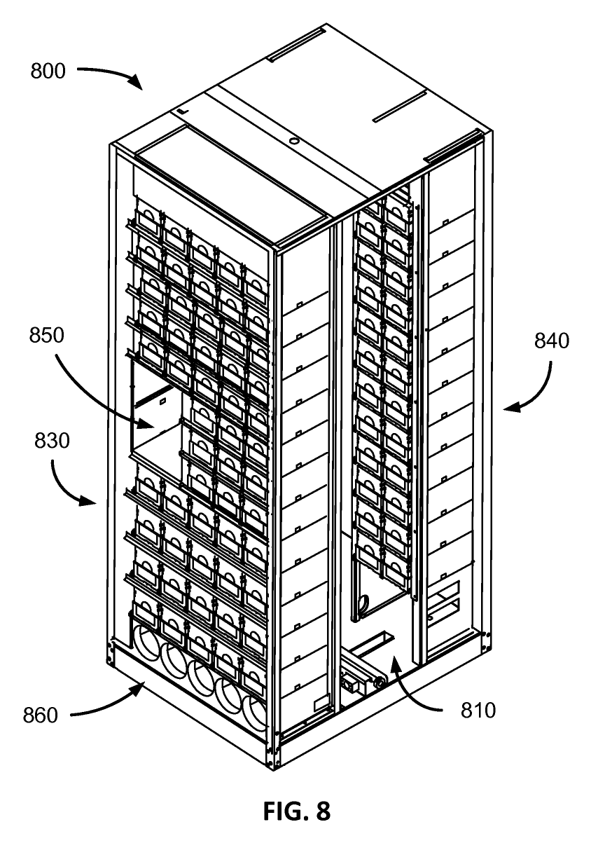

Embodiments of the present invention can be commercially practiced in a Spectra Logic T-950 tape cartridge library manufactured by Spectra Logic of Boulder Colo. FIG. 8 shows a commercial embodiment of one T-950 unit 800 without an enclosure. The T-950 library 800 comprises a first and second shelf system 830 and 840 that are adapted to support a plurality of the mobile media, such as the tape cartridge magazine 206 comprising a plurality of LTO-3 tape cartridges with MAMs, archived by the library 800. The shelf systems 830 and 840 can each comprise at least one auxiliary memory reader, such as the auxiliary memory reader 232 of FIG. 2A. Furthermore, the second shelf system 840 comprises at least one four IBM LTO-3 drives that each comprise an SCD (not shown) and are adapted to read and write data to and from a tape cartridge. The IBM LTO-3 drives each have the capability of storing data to an auxiliary radio frequency memory device 104 contained in an LTO-3 cartridge. Functionally interposed between the first and second shelf system 830 and 840 is a magazine transport space 810. The magazine transport space 810 is adapted to provide adequate space for a tape cartridge magazine 206 to be moved, via a magazine transport and cartridge picker (not shown), from a position in the first shelf system 830, for example, to a drive. The magazine transport and picker can further accommodate at least one auxiliary radio frequency reader and writer device, such as the reader 234 from FIG. 2A. Tape cartridge magazines 206 can be transferred into and out from the T-950 library 800 via an entry/exit port 850. An auxiliary radio frequency reader and writer device, such as the reader 236 from FIG. 2A, can be associated with the entry/exit port 850. Transferring tape cartridge magazines 206 in and out of the T-950 library 800 can be accomplished by an operator for example. The T-950 library 800 comprises a means for cooling as shown by the fans 860, located at the base of the library 800. The T-950 library 800 can be linked to a central data base, such as the data base 702, wherein the central data base can provide storage of all interaction assessment records whether or not obtained from auxiliary radio frequency memory devices, such as the device 104, contained in each tape cartridge in the T-950 library 800 as read by any one of the auxiliary radio frequency reader and writer devices. The T-950library 800 also provides a graphical user interface (not shown) whereon a display table much like those illustrated in FIGS. 6A-6C can be displayed. In an alternative embodiment, simple messages pertaining action associated with a tape cartridge and or tape drives can be displayed, such as an alert accompanying a sound alarm, for example.

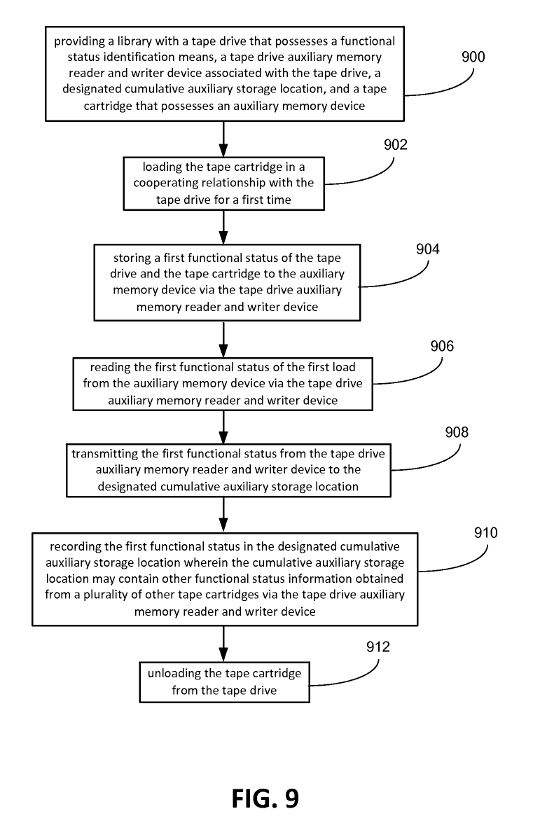

Referring now to FIG. 9 in conjunction with FIG. 2A, shown therein is a method to practice an embodiment of the present invention. It should be recognized that the steps presented in the described embodiments of the present invention do not necessarily require any particular sequence unless otherwise stated. As shown in step 900, a library 200 is provided with a tape drive 224 that possesses a functional status identification capability displaying on an SCD, for example, a tape drive auxiliary memory reader and writer device 230 associated with the tape drive 224, a designated cumulative auxiliary storage location 240, and a tape cartridge 201 that possesses an auxiliary memory device 104. As shown in step 902, the tape cartridge 201 is loaded in a cooperating relationship with the tape drive 224 for a first time. As shown in step 904, a first functional status of the tape drive 224 and the tape cartridge 201 is stored to the auxiliary memory device 104 via the tape drive auxiliary memory reader and writer device 230. As shown in step 906, the first functional status of the first load is read from the auxiliary memory device 104 via the tape drive auxiliary memory reader and writer device 230. As shown in step 908, the first functional status is transmitted from the tape drive auxiliary memory reader and writer device 230 to the designated cumulative auxiliary storage location 240. Optionally, another embodiment contemplates that tape drive transmitting an interaction assessment record to the designated cumulative auxiliary storage location 240. Step 908 can be performed after step 906 or after unloading the tape cartridge 201 and re-loading the tape cartridge 201 a later time. As shown in step 910, the first functional status is recorded in the designated cumulative auxiliary storage location 240 wherein the cumulative auxiliary storage location 240 may contain other functional status information obtained from a plurality of other tape cartridges 100 via the tape drive auxiliary memory reader and writer device 230. In an alternative embodiment, other auxiliary memory reader and writer devices, such as 232 and 234 can be used to complete this step. As shown in step 912, the tape cartridge 201 is unloaded from the tape drive 224.

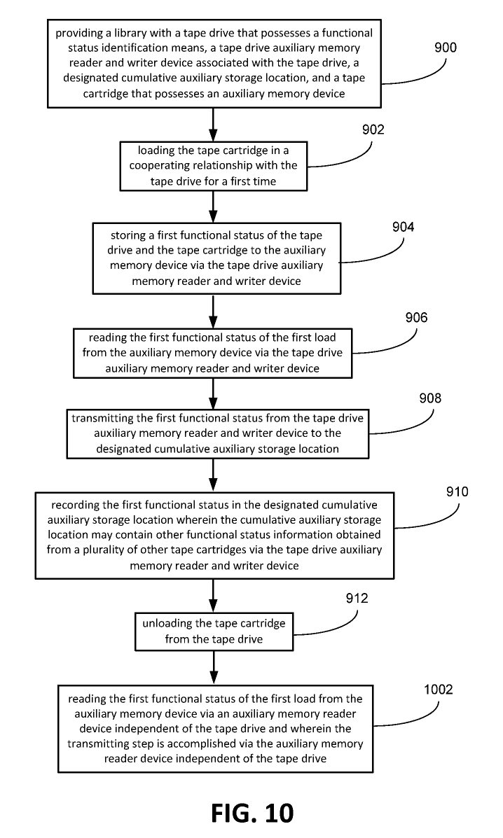

FIG. 10 shows some alternative embodiments of the present invention which includes method steps 902, 904, 906, 908, 910 and 912 from FIG. 9. For the embodiment in step 1002, the first functional status of the first cartridge/drive interaction is read from the auxiliary memory device 104 via an auxiliary memory reader device independent of the tape drive 224, such as the reader device 232, for example, and wherein the transmitting step 908 is accomplished via the auxiliary memory reader device independent of the tape drive 224. In yet another alternative embodiment, the method of shown in FIG. 9 can include steps to load the tape cartridge 201 in a cooperating relationship with the tape drive 224 for a second time, store a second functional status of the tape drive 224 and the tape cartridge 201 to the auxiliary memory device via the tape drive auxiliary memory reader and writer device 230, read the second functional status of the second load from the via the tape drive auxiliary memory reader and writer device 230, transmit the first and the second functional status from the tape drive auxiliary memory reader and writer device 230 to the designated cumulative auxiliary storage location 240, and record the first and the second functional status in the designated cumulative auxiliary storage location 240. In yet another alternative embodiment, the method of shown in FIG. 9 can include steps to provide a second tape drive 222 that possesses a second functional status identification means 272, a second tape drive auxiliary memory reader and writer device 230 associated with the second tape drive 222, load the tape cartridge 201 in a cooperating relationship with the second tape drive 222, store a second functional status of the tape drive 222 and the tape cartridge 201 to the auxiliary memory device 104 via the tape drive auxiliary memory reader and writer device 230 associated with the second tape drive 222, read the second functional status of the load with the second drive 222 from the auxiliary memory device 104 via the second tape drive auxiliary memory reader and writer device 230, transmit the first and the second functional status from the second tape drive auxiliary memory reader and writer device 230 to the designated cumulative auxiliary storage location 240, and record the first and the second functional status in the designated cumulative auxiliary storage location 240.

In yet another embodiment of the present invention, tape drive health can be managed over the life cycle of the tape drive 275 via the library 200. In one embodiment, the library 200 can use a combination of information received from the tape drive 275, such as information corresponding to the SCD 270, after every tape cartridge 100 unloads in order to determine the status condition, or “health”, of the tape drive 275 via the tape drive 275 and tape cartridge interaction. The information used can, for example, comprise the information corresponding to the SCD 270, tape alerts, and any errors detected at the time the tape cartridge 100 is unloaded from the tape drive 275. A “tape alert” message is a critical, warning or informational alert that occurred due to a tape drive or robotic library hardware event generally transmitted to a user in a viewable format, such as on a display screen, for example. Tape alerts are generated when the tape drive or tape experiences the following conditions: drive recoverable read problems, drive recoverable write problems, drive unrecoverable read problems, drive unrecoverable write problems, drive hardware defects, worn-out media, expired cleaning tapes, wrong media used, abnormal error conditions, auto loader/library mechanical problems, auto loader/library environmental conditions. The errors detected may be errors in the tape drive or errors in the reading and writing process, e.g., soft errors or hard errors (soft errors are errors that are recoverable and hard errors are errors that are not recoverable). Optionally, other information that is detected by the tape drive 275 can also be obtainable and collected via the library 200. The information can be stored in an auxiliary memory device in the library 200, such as the auxiliary storage 240. The library 200 can be enabled to assess the status condition of the tape drive 275 based on the information collected. For example, an algorithm can be configured to send a message, such as to the GUI 218, or other display devices, paper, etc., indicating that the tape drive 275 is “functioning properly”, “action required”, or “needs replacing”, for example. Such an algorithm can be run by processors in the library 200 (via the central processing unit) over the library's Computer Area Network (CAN) that draw the information directly from the tape drive 275 or via the auxiliary memory 240, for example. Assessment of the information can be established over multiple tape cartridge loads and unloads, and/or over a variety of tape cartridges 100 loaded and unloaded from a single tape drive 275. Also, in an alternative embodiment, assessments of tape drive health can include assessing how a tape cartridge 100 has performed in all of the tape drives that the tape cartridge 100 has encountered in a loading and unloading operation, i.e., the history of the tape cartridge 100 interaction with a tape drive. For example, a tape cartridge 100 that has been involved in an “action required” status over multiple tape drives may be an indication that a problem lays with the tape cartridge 100 and not a specific tape drive. The tape cartridge history can be obtained from the auxiliary storage 240 or via the MAM 104 in the tape cartridge 100.

The library 200, in one embodiment, may be required to follow specific actions pertaining to how a tape drive 275 is managed based on the information corresponding to the SCD 270. The specific actions may also have an effect on specific actions directed to a tape drive 275, such as replacing or cleaning, for example. For example, a ‘C’ error code corresponding to the SCD 270 indicates that the tape drive 270 requires cleaning. The library 200 may cease to store data for a host 202 or the specific tape drive 275 may be taken “off-line” until the tape drive is cleaned. After the tape drive 270 is cleaned, the tape drive's status condition may be returned to “functioning properly”, or “good” status, and the library 200 returned to normal operations. In yet another example, in the event a tape drive 275 runs a drive self test, which is a test evaluating a plurality of functional sequences and operations performed by the tape drive 275, and the tape drive 275 fails the self test, the tape drive 275 status condition is changed to “needs to be replaced”. Upon passing the self test, a tape drive 275 status condition is marked “good”. Other examples of tape drive evaluation may include power usage (i.e., excessive power usage may be an indication that the tape drive is faulty) and operating temperature (i.e., the tape drive is operating at a temperature that exceeds acceptable limits). Under such examples, a tape drive status condition can be assessed. In an optional embodiment, the history of information collected at each load and/or unload may be stored in a non-volatile memory that is different from the auxiliary memory 240.

In an optional embodiment, evaluation of a tape drive 275 may be assessed via an external means such as a camera system adapted to monitor normal behavior or the tape drive 275 and/or other devices within the library 200. In such a circumstance, a camera system (i.e., a video camera or a camera that is triggered by a rogue event) may transmit observed information to the auxiliary memory device 240 or other non-volatile memory device used in conjunction with the library 200 to assess the drive or other components within the library 200.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, multiple auxiliary memory reader devices independent of a tape drive can be used inside of a library with one or more tape cartridge's associated auxiliary memory device at the same time while still maintaining substantially the same functionality without departing from the scope and spirit of the present invention. Another example can include using tape drives that do not have SCD's but do, however, have the capability of determining at least one functional status when loaded with a tape cartridge and transferring knowledge of the functional status to the tape's auxiliary radio frequency memory device 104 or optionally directly to an auxiliary storage device, such as the device 240, while still maintaining substantially the same functionality without departing from the scope and spirit of the present invention. Another example can include using auxiliary memory reader devices independent of a tape drive to check accuracy of data via redundancy not to mention techniques in which data from multiple tape cartridges, via their associated auxiliary memory devices, can be accumulated coincidentally, just to name a few examples while still maintaining substantially the same functionality without departing from the scope and spirit of the present invention. Further, though elements and methods are described herein exemplifying a first and second object or element, for example, this language is used herein to simplify the description indicative of a plurality of objects or elements. Finally, although the preferred embodiments described herein are directed to tape library systems, RF devices, SCD tape drives and related technology, it will be appreciated by those skilled in the art that the teachings of the present invention can be applied to other remote communication systems and devices, without departing from the spirit and scope of the present invention.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed and as defined in the appended claims.

What is claimed is:

1. A tape storage library comprising:
a plurality of tape cartridges each including an associated auxiliary memory device;
a first tape drive and a second tape drive substantially disposed in said tape storage library;
a data base adapted to maintain functional status records respecting each interaction, wherein said interaction is defined by a physical engagement between one of said tape cartridges and one of said tape drives;
a means for transferring said functional status records of at least one of said interactions from said data base to one of said auxiliary memory devices such that said associated tape cartridge possesses a history of said interactions specific to said tape cartridge;
a data analysis system adapted to perform an analysis of said functional status records maintained in said data base; and
a reporting system adapted to report a tape drive health condition of said first and said second tape drives to an end user based on said analysis of said functional status records.

2. The tape storage library of claim 1 wherein said first tape drive and said second tape drive each possess an auxiliary reader and writer device adapted to transfer said functional status records to and from each of said associated auxiliary memory devices.

3. The tape storage library of claim 1 wherein said functional status records include incidences when there is an error associated with said interaction.

4. The tape storage library of claim 3 wherein said reporting system is adapted to report said tape drive health condition as problematic if a threshold is reached of accumulated errors.

5. The tape storage library of claim 4 wherein said reporting system is adapted to report said tape drive health condition when said threshold of accumulated errors is reached for either said first tape drive or said second tape drive.

6. The tape storage library of claim 3 wherein said reporting system is adapted to report said tape drive health condition as problematic when said error is of a type having a predetermined level of severity.

7. The tape storage library of claim 1 wherein said data base is adapted to receive said records respecting each of said interactions from either said first tape drive or said second tape drive.

8. The tape storage library of claim 1 wherein said data base is adapted to receive said records respecting each of said interactions from each of said auxiliary memory devices.

9. The tape storage library of claim 1 wherein each of said auxiliary memory devices comprise radio frequency auxiliary memory devices.

10. The tape storage library of claim 1 further comprising a third tape drive.

11. The tape storage library of claim 1 further comprising a display device adapted to be viewed by an end user and wherein said reporting system is adapted to report said tape drive health condition via said display device.

12. The tape storage library of claim 1 wherein said data analysis system includes a computer central processing unit and a storage device including electronically stored, readable, and executable instructions in the form of an algorithm adapted to be read and executed via said computer central processing unit.

13. The tape storage library of claim 12 wherein said analysis includes tallying said interactions that contain errors.

14. The tape storage library of claim 13 wherein said analysis includes further tallying said interactions that are free of errors.

15. A method comprising:
providing a tape library including a plurality of tape cartridges, a plurality of tape drives, and a data base;
forming an interaction between one of said tape cartridges and one of said tape drives wherein said interaction is defined by a physical engagement between said one tape cartridge and said one tape drive;
assessing a first functional status associated with said interaction;
recording in said data base said assessed first functional status in association with an identification of said one tape cartridge and said one tape drive;
determining whether said data base has recorded any other assessed function status associated with an interaction between others of said tape cartridges and others of said tape drives;
correlating said first function status with any said other assessed functional status recorded in said data base according to predetermined parameters;
reporting the correlation to an end user.

16. The method of claim 15 wherein one of said parameters is the number of functional statuses that deviate from a trouble-free interaction wherein said trouble-free interaction is defined as when said interaction is devoid of any deviations from an expected interaction outcome free of unexpected errors.

17. The method of claim 16 further comprising taking action in response to said correlation report by either disabling one of said tape drives, replacing one of said tape drives, disabling one of tape cartridges, or replacing one of said tape cartridges.

18. The method of claim 15 further comprising providing an auxiliary memory device associated with at least one of said tape cartridges and recording said first functional status in association with an identification of said one tape drive in said auxiliary memory device.

19. The method of claim 15 further comprising providing a single character display associated with at least one of said tape drives and displaying said first functional status on said display.

20. A tape library comprising:
a plurality of tape drives and a plurality of tape cartridges substantially disposed in said tape library;
a database including a plurality of interaction assessment records corresponding to a plurality of respective interaction events wherein each of said interaction events comprises physical and electrical sequences associated with any of said tape cartridges and any of said tape drives when physically engaged, and wherein each of said interaction assessment records includes a tape drive indicia associated with one of said tape drives, a tape cartridge indicia associated with one of said tape cartridges, and a functional status of said interaction events;
a table listing said functional statuses for said interaction events involving each of said tape drives.

21. The tape library of claim 20 further comprising a visually observable report showing said table listing.

22. The tape library of claim 20 where each of said tape cartridges possesses an auxiliary memory device that maintains a record of said tape drive indicia and said functional status for at least one interaction event associated with said associated tape cartridge.

23. The tape library of claim 20 further comprising a means for alerting an end user when said interaction assessment records indicate that the functional status of said interaction events involving any one of said tape drives deviates from an expected, predetermined outcome.

24. A tape library containing a data base that is adapted to maintain character display information for at least two interactions wherein each interaction occurs when one of a plurality of tape drives physically engages one of a plurality of tape cartridges, said library adapted to report said character display information tied to said interactions from said data base.
